(19) United States
(12) Patent Application Publication
(10) Pub. No.: US 2016/0352285 A1
(43) Pub. Date: Dec. 1, 2016

(54) FIELD-DEPLOYABLE SELF-CONTAINED PHOTOVOLTAIC POWER SYSTEM

(71) Applicant: SolarCity Corporation, San Mateo, CA (US)

(72) Inventors: Martin Seery, San Rafael, CA (US); Tyrus Hudson, San Rafael, CA (US); Katie Pesce, San Rafael, CA (US)

(21) Appl. No.: 14/956,273

(22) Filed: Dec. 1, 2015

Related U.S. Application Data
(60) Provisional application No. 62/166,456, filed on May 26, 2015.

(51) Int. Cl. H02S 30/20; H02S 10/40; H02S 20/00

(52) U.S. Cl. CPC H02S 30/20; H02S 20/00; H02S 10/40

(57) ABSTRACT

A field-deployable photovoltaic power system having solar modules and associated electronics that are stored in a standard shipping container and are manually deployed to form an array above the shipping container, with the shipping container providing the structural base for the photovoltaic array disposed thereabove.

### CROSS-REFERENCE TO RELATED APPLICATION

The present disclosure claims the benefit of U.S. Provisional Patent Application No. 62/166,456 (Attorney Docket Number P164-1PUS), entitled “FIELD-DEPLOYABLE SELF-CONTAINED PHOTOVOLTAIC POWER SYSTEM,” filed on May 26, 2015, which is herein incorporated by reference in its entirety.

### TECHNICAL FIELD

The present invention relates to field-deployable, off-grid systems for producing electrical power from solar photovoltaic modules.

### BACKGROUND OF THE INVENTION

Photovoltaic systems are often deployed on a relatively large scale, over a large area that can be referred to as a solar power farm, or the like. Such solar power farms are generally connected to a power grid. However, there can be some locations or applications where an off-grid power source may have greater utility, or where standard grid power is unavailable.

Accordingly, there is a need for an off-grid power supply, and particularly a need for a self-powered power supply, as can be provided by a solar panel deployment.

### BRIEF SUMMARY OF THE INVENTION

The present system provides a field-deployable power supply to provide off-grid, remote power. The present system is self-contained and self-powered, and is further designed to provide electrical power at the location to which the system is delivered.

An advantage of the present system is that it is delivered to a remote job site in a standard shipping container using a truck and crane. The shipping containers considered for this application include, but are not limited to twenty foot (20′), thirty foot (30′), and forty foot (40′) ISO freight containers. The shipping container serves dual functions: as the box in which the entire system is stored and transported, and as part of the supporting structure underneath the deployed photovoltaic array.

The entire system is delivered in the shipping container and includes solar photovoltaic modules to for the array, solar mounting components, batteries, an intelligent control system, and the supporting electronics to supply energy. Various assembly components and tools (e.g. a hoist, cables, a ladder, etc.) can also be included within the shipping container. Advantageously, the system is pre-wired, and all components for a fully functioning system are included inside the shipping container.

A further advantage of the present system is that the storage batteries and the associated electronics remain within the storage container during use. Maintaining the storage batteries and the associated electronics within the storage container provides security for the components since the shipping container can be locked and secured. Additionally, the deployed array of photovoltaic modules can be positioned up high over the top of the shipping container. The deployment of photovoltaic modules above the storage container also has the advantage of physically shading the shipping container, which protects the batteries and other sensitive electronics stored therein. Further, the shipping container acts as a supporting base for the photovoltaic modules and modules support structures such that the deployed photovoltaic array can be positioned at a safe and secure height off of the ground.

A further advantage of the present system is that the array of photovoltaic modules can be assembled by a minimum number of installers (e.g. one, two, three, or four or more individuals) working manually, that is, without engine-driven machinery. Moreover, assembly of the photovoltaic modules onto support structures can primarily be performed with one or more installers working on the ground, minimizing both risk and complexity of the assembly process. In other words, manual assembly of the present system does not require the use of scaffolding or a crane to assemble either the rows of photovoltaic modules or the photovoltaic array as a whole. Thus, it is not even necessary to use powered lifting equipment to assemble the array in a deployed, raised position above the shipping container. Rather, full deployment can be accomplished by simple manual mechanical winches and hoisting systems to raise or lower portions of the photovoltaic array. In some aspects, a final or a connecting set of photovoltaic modules can be connected to form part of the photovoltaic array by an installer working on the roof of the shipping container, and/or on a ladder next to the shipping container. Assembly of the present system is therefore quiet, and it also requires little (or no) maintenance.

In some embodiments, the present disclosure is directed to a field-deployable self-contained photovoltaic power system, including: (a) a shipping container; (b) multiple mounting structures, each mounting structure being pivotally connected to an exterior surface of the shipping container; (c) multiple photovoltaic modules, each photovoltaic module being attachable onto one of the mounting structures; and (d) at least one hoist for rotating the mounting structures from a lowered position at which the photovoltaic modules can be manually attached onto the mounting structures by an installer on the ground to a raised position where the photovoltaic modules are disposed in a photovoltaic array at a height above the shipping container. The present system can further have mounting structures and photovoltaic modules all stored within the shipping container prior to deployment. In some aspects, each mounting structure can be constructed of a first frame member having a bottom end rotatably connected to a bottom edge of the shipping container; and a second frame member connected to a top end of the first member. In such aspects, the second frame member can be connected at a right angle to the first frame member, the first frame member can rotate to a vertical position when the array is in the raised position above the shipping container, the first frame member can be attached onto a top edge of the shipping container when the array is in the raised position above the shipping container, and/or the second frame member can rotate to an approximately horizontal position when the array is in the raised position above the shipping container.

In some embodiments, the system further includes a third frame member connected at opposite ends to each of the first and second frame members, the third frame member supporting a free end of the second frame member when the second frame member is rotated into a raised position. In such aspects, the third frame member can be connected at 60 degree angles to each of the first and second frame members, and/or the free end of the second frame member can rest on the ground when the mounting structure is in the lowered position. In some aspects, the multiple mounting structures include having mounting structures on opposite sides of the shipping container that, when rotated to the raised position, support a photovoltaic module array that extends over the top of the shipping container. In such aspects, the photovoltaic module array can include a center row of modules suspended by both of the mounting structures on opposites sides thereof. Further, the shipping container can act as a counter-balance that remains in position as the mounting structures are raised on opposite sides thereof. In some aspects, the hoist is manually operable to raise each of the mounting supports, and/or guide wires can extend downwardly and/or outwardly away from four corners of the photovoltaic array. In some aspects, the system can also include three mounting rails spanning across each of the second frame members of the multiple mounting structures. In such aspects, the three mounting rails can include a top mounting rail, a center mounting rail and a bottom mounting rail, where the top, center and bottom mounting rails are all disposed parallel to one another, and/or where an installer standing on the ground can reach each of the three mounting rails when the mounting structure is in the lowered position. In such aspects, upper and lower rows of photovoltaic modules are pivot connected onto the center mounting rail with bottom edges of the upper row of photovoltaic modules being connected to the center mounting rail and top edges of the lower photovoltaic modules being connected to the center mounting rail. In some aspects, the system also includes at least one battery in the shipping container, the battery being electrically connected to store energy generated by the photovoltaic modules.

In some embodiments, the present disclosure is directed to a field-deployable self-contained photovoltaic power system, having: a shipping container; mounting structures, each mounting structure being pivotally connected to an exterior surface of the shipping container, and each mounting structure being movable between a lowered position and a raised position; and photovoltaic modules, each photovoltaic module being attachable onto one of the mounting structures, where the mounting structures in the lowered position are configured to receive and attach to the photovoltaic modules, and where the mounting structures in the raised position, with the photovoltaic modules attached thereto, form a photovoltaic array.

In some aspects, the mountings structures can be space frames that are triangular, and can be pivotally connected to a bottom surface or edge of the shipping container. In some aspects, the mounting structures can be arranged on opposite sides of the shipping container, such that the mounting structures in their raised position, with the photovoltaic modules attached thereto, supports the photovoltaic array which extends over the top of the shipping container. In some aspects, the photovoltaic module array can include a center row of photovoltaic modules suspended by both of the mounting structures on opposites sides thereof. Each mounting structure can be constructed of a first frame member having a bottom end rotatably connected to a bottom edge of the shipping container, a second frame member connected to a top end of the first member, and a third frame member connected at opposite ends to each of the first and second frame members, where, when the mounting structure in the raised position, the third frame member can support a free end of the second frame member. With the mounting structure in the raised position, the first frame member can rotate to a vertical position, attach onto a top edge of the shipping container, and be in the raised position above the shipping container. With the mounting structure in the raised position, the second frame member can be rotated to a generally horizontal position above the shipping container. In some aspects, the third frame member can be connected at 45 degree angles to each of the first and second frame members. Optionally, guide wires connected to at least one of the four corners of the photovoltaic array can extending outwardly away from the photovoltaic array and anchor in the ground. Further mounting rails can span across each of the second frame members of the mounting structures, and can be disposed parallel to one another. In some aspects, there can be four mounting rails, which can be can be referred to as an outer mounting rail, a first lateral mounting rail, a second lateral mounting rail, and an inner mounting rail. In some such aspects, an upper row and a lower row of photovoltaic modules can be pivot connected onto the first lateral mounting rail with bottom edges of the upper row of photovoltaic modules being connected to the first lateral mounting rail and top edges of the lower photovoltaic modules being connected to the first lateral mounting rail. In some embodiments, the field-deployable self-contained photovoltaic power system can further include at least one inverter configured to convert energy generated by the photovoltaic array from direct current to alternating current; and at least one battery in the shipping container, the battery being electrically connected to store energy generated by the photovoltaic array.

In some embodiments, the present disclosure is directed to a method of deploying a self-contained photovoltaic power system, where the method can include the steps of: withdrawing components for mounting structures and photovoltaic modules from within a shipping container; assembling the mounting structures on opposite sides of the shipping container, each mounting structure pivotally connected to an exterior surface of the shipping container, and movable between a lowered position and a raised position; on the opposite sides of the shipping container, connecting the mounting structures to each other with a plurality of mounting rails; with the mounting structures in a lowered position on the ground, attaching a some of the photovoltaic modules to the mounting rails; manually raising each mounting structures on both sides of the shipping container to the raised position, which positions the attached photovoltaic modules above the shipping container; and mounting a further number of photovoltaic modules between the mounting structures in the raised position, thereby forming a photovoltaic array. In some aspects, manually raising each plurality of mounting structures is performed with a hoist and cable manually operable by an installer. In some aspects, the shipping container acts as a counter-balance and remains in position as the mounting structures are raised on opposite sides thereof. The mounting structures can be raised alternatingly on either side of the shipping container, and can be generally triangular in construction. In some aspects, mounting the photovoltaic modules between the mounting structures when the mounting structures are in the raised position is performed by an installer positioned on top of the shipping container. In many aspects, the photovoltaic modules are attached to the mounting rails on a side of the shipping container in two rows by an installer located on the ground.

Additionally, the present system is scalable as individual systems can be deployed and networked together to meet demand, should the demand exceed the power produced by one of the one of the present systems standing alone. As used herein, any individual field-deployable power supply system can be referred to as a “microgrid”. Similarly, a networked plurality of the present field-deployable power supply systems can be also be considered as a “microgrid” or a “microgrid network”. In other words, a microgrid can refer to a localized power supply, or a localized collection of connected power supplies that form a relatively small power grid, that is not connected to a standard power grid or otherwise off-grid.

### BRIEF DESCRIPTION OF THE DRAWINGS

Illustrative aspects of the present disclosure are described in detail below with reference to the following drawing figures. It is intended that that embodiments and figures disclosed herein are to be considered illustrative rather than restrictive.

FIG. 1 is a perspective view of an assembled field-deployable power supply system (microgrid) array, showing the array of photovoltaic modules disposed above the shipping container, according to embodiments of the disclosure.

FIG. 2 is a perspective view of a first step of assembling a field-deployable power supply system in which external mounting structures are assembled in their lowered position, according to embodiments of the disclosure.

FIG. 3 is a perspective view of a second step in which four mounting rails are attached onto the mounting structures of FIG. 2.

FIG. 4 is a perspective view that corresponds to FIG. 3, after a first upper module has been attached to the mounting structure.

FIG. 5 is a perspective view that corresponds to FIG. 4, after an upper row of modules has been installed on the mounting structure.

FIG. 6 is a perspective view that corresponds to FIG. 5, after a first lower module has been attached to the mounting structure.

FIG. 7 is a perspective view similar to FIG. 6, showing the mounting structures on both sides of the shipping container in their lowered position.

FIG. 8 is a side elevation view corresponding to FIG. 7.

FIG. 9 is a view similar to FIG. 8, with one of the mounting structures (and its associated two rows of photovoltaic modules) lifted into their final deployed position.

FIGS. 9A-9D are partial views of FIG. 9, showing alternative mounting structures, according to embodiments of the disclosure.

FIG. 10 is a perspective view of the system, showing both of the mounting structures lifted into their final positions (such that the photovoltaic array is positioned above the top height of the shipping container), according to embodiments of the disclosure.

FIG. 11 is a view similar to FIG. 10, after the addition of a first module in a middle row of the array has been added thereto.

FIG. 12 is a view similar to FIG. 11, after the entire middle row of photovoltaic modules has been added.

FIG. 13 is a detail view of a bottom side of the shipping container showing further details of the pivot connection between the first frame members of the mounting supports and the shipping container, according to embodiments of the disclosure.

FIG. 14 is a detail view of a top perspective view of the shipping container showing further details of the hoist cable and system for attaching the top ends of the first frame members to the top side edges of the shipping container, according to embodiments of the disclosure.

FIG. 15 illustrates further details of the three mounting rails, according to embodiments of the disclosure.

FIG. 16 illustrates further details of the connector on the middle mounting rail of FIG. 15.

FIG. 17 is a cut-away perspective view of the shipping container showing the components of the present system stored therein, according to embodiments of the disclosure.

FIG. 18 is a top plan view corresponding to FIG. 17.

### DETAILED DESCRIPTION OF THE INVENTION

Throughout this description for the purposes of explanation, numerous specific details are set forth in order to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

The present invention provides a field-deployable photovoltaic power system having photovoltaic modules and associated electronics that are stored in a standard shipping container. These photovoltaic modules are manually assembled into a photovoltaic array that is deployed to a position above the shipping container. Advantageously, the majority of the photovoltaic array assembly can be done on the ground by the installers who then manually raise the array into position above the shipping container. Moreover, assembly of the field-deployable photovoltaic power system can be accomplished by a minimal number of installers without the need for a separate scaffolding, a crane, or engine-driven machinery. Also advantageously, the shipping container provides the structural base for the photovoltaic array, and housing for several of the sensitive system components after deployment. Further, the shipping container can generally act as a ballast for the overall microgrid system.

The present field-deployable photovoltaic power system also provides for a power supply that has a relatively small footprint, allowing the microgrid to be deployed in a wide variety of locations. Further, the small footprint of the microgrid allows for deployment of the power supply without the need for excessive landscaping or leveling of an area of ground before setting up the microgrid. The flexibility in deployment locations provided by the footprint of the microgrid makes the power system advantageous for use in several applications, such as for military deployments, disaster relief deployments, water pumping stations, challenging terrain locations (such as mountainous terrain), or the like.

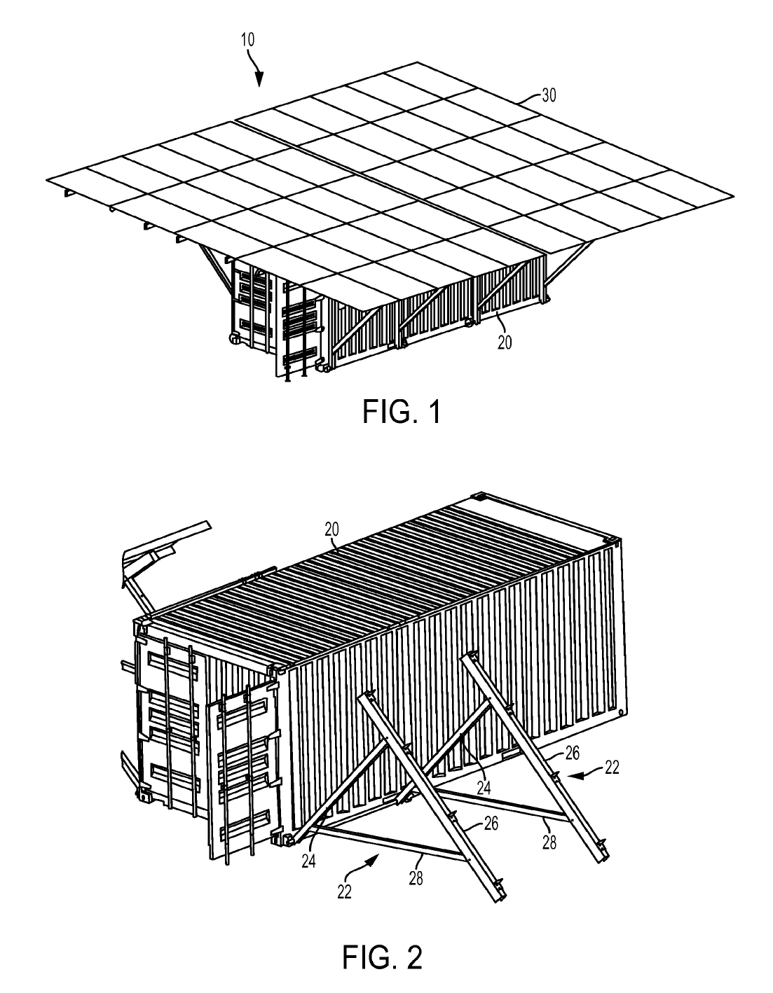

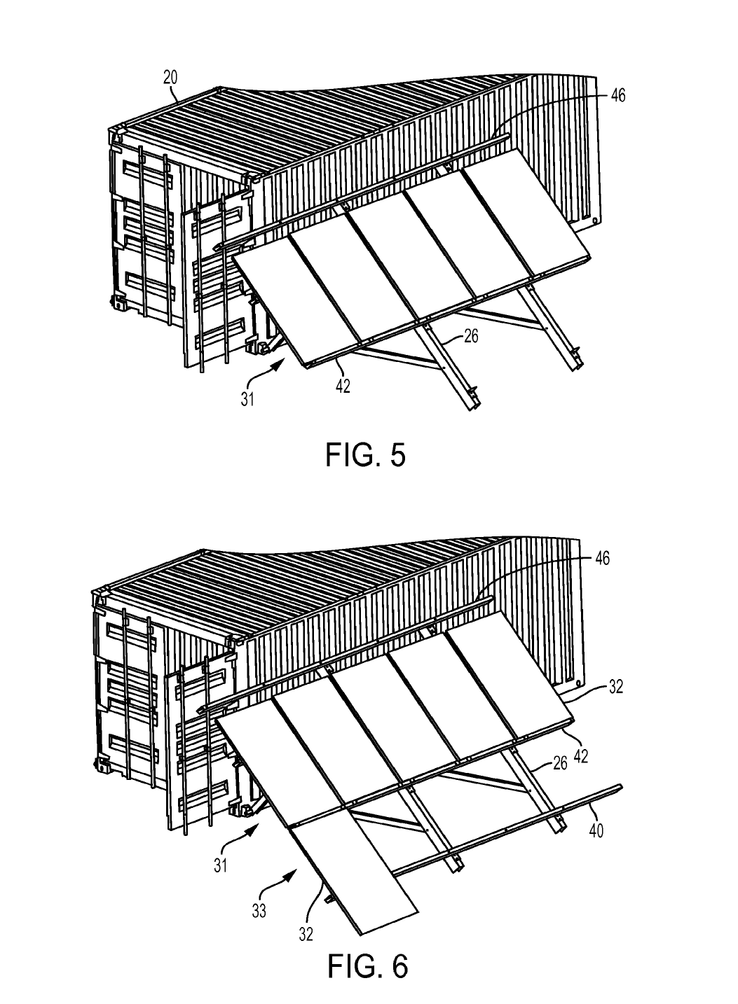

FIG. 1 shows the final assembled structure of a field-deployable photovoltaic power system, and FIG. 2 through FIG. 12 show sequential steps in the assembly and deployment of the system. Specifically, microgrid 10 is shown with standard twenty foot (20′) shipping container 20 with photovoltaic array 30 disposed above the top of shipping container 20. Photovoltaic array 30 is supported by a structure coupled to the sides (referring to the longitudinal dimension) of shipping container 20. In some embodiments, photovoltaic array 30 can extend past the ends of shipping container 20 (where the “ends” refer to the sides of a shipping container having a narrower width dimension, which include the door of a shipping container). Generally, shipping container 20 can have a bottom portion, a roof portion, and wall portions separating the bottom portion and the roof portion, where in one end of the wall portions can be the door of shipping container 20.

Referring next to FIG. 2, showing a perspective view of a first phase of assembling a field-deployable power supply system, where shipping container 20 is first opened at the jobsite and the mounting system hardware (stored inside) is removed. Next, plurality of mounting structures 22 are assembled in a lowered position. In various aspects, mounting structures 22 can be constructed as space frames, referring to a general framing shape that can both support the mounting of photovoltaic modules when mounting structures 22 are in a lowered position resting on the ground and can support photovoltaic array 30 above shipping container 20 when mounting structures 22 are in a vertical or raised position alongside the walls of shipping container 20. In some aspects mounting structure 22 space frames can be triangular, boxed, arched, partially curved, or a combination thereof.

In aspects as shown, components of mounting structures 22 include, first frame member 24, second frame member 26, and third frame member 28, along with fastening hardware (e.g. nuts, bolts, etc.) as necessary to couple the components of mounting structures 22. Mounting structures 22 are each pivotally connected to the bottom exterior side of shipping container 20 as shown. Each mounting structure 22 includes first frame member 24 having a bottom end that is rotatably connected to shipping container 20, and second frame member 26 this is connected to a top end of first frame member 24. Preferably, first frame member 24 and second frame member 26 are connected at right angles, or near right angles as shown. Third frame member 28 is connected at opposite ends of third frame member 28 to first frame member 24 and second frame member 26. In some embodiments, third frame member 28 is connected at forty-five degree (45°) angles to each of first frame member 24 and second frame member 26, respectively, as shown. Accordingly, each mounting structure 22 can form a triangular support structure.

In some aspects, third frame member 28 can be an arched member, and can be assembled to be oriented in either a convex or concave direction, relative to the walls of shipping container 20. In other aspects, third frame member 28 can be constructed of two components joined at an angle, or a single bent member, to form in combination with first frame member 24 and second frame member 26, a boxed frame shape for mounting structure 22. In further aspects, third frame member 28 can be constructed of two components joined at an angle, or a single bent member, to form in combination with first frame member 24 and second frame member 26, a chevron-shaped frame shape for mounting structure 22. In all embodiments, mounting structures 22 are capable of supporting photovoltaic modules 32 above shipping container 20, independent of the structural foundation of shipping container 20.

As shown in FIG. 2, two mounting structures 22 are provided, although in various embodiments, three, four, or more than four mounting structures 22 can be provided on a side of shipping container 20. In some aspects, a first end of third frame member 28 can be connected to first frame member 24 proximate to where first frame member 24 is pivotally connected to the bottom exterior side of shipping container 20, while in other aspects, the first end of third frame member 28 can be connected to first frame member 24 proximate to where first frame member 24 connects to second frame member 26. Further, in some aspects, a second end of third frame member 28 can be connected to second frame member 26 proximate to where second frame member 26 connects to first frame member 24, while in other aspects, second end of third frame member 28 can be connected to second frame member 26 proximate to where second frame member 26 defines an edge of the ultimately assembled photovoltaic array 30.

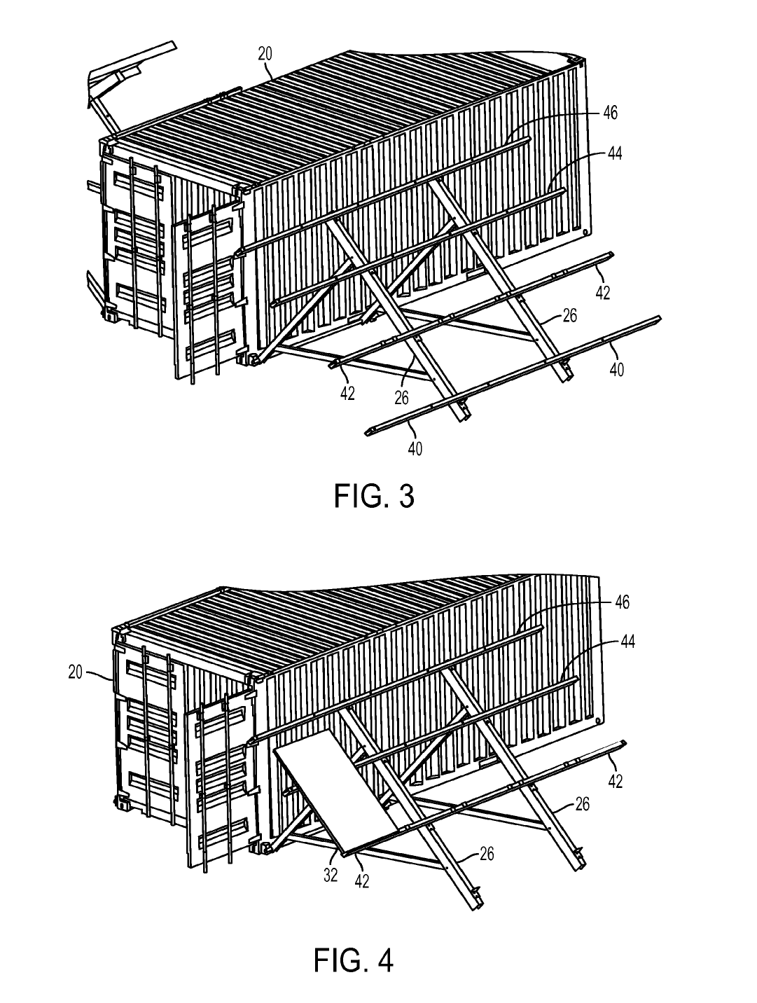

Next, as shown in FIG. 3, four parallel mounting rails, outer rail 40, first lateral rail 42, second lateral rail 44, and inner rail 46 are attached onto the top of second frame members 26 of two mounting structures 22. Each of outer rail 40, first lateral rail 42, second lateral rail 44, and inner rail 46 are arranged as parallel to the length of shipping container 20. In various embodiments, each of outer rail 40, first lateral rail 42, second lateral rail 44, and inner rail 46 can extend along length of shipping container 20 past the point of connection between any given second frame member 26 and the respective mounting rails. Once connected by mounting rails, mounting structures 22 as shown will move and rotate in concert with each other as a single overall structure. In alternative aspects, connective rail structures can connect to first frame members 24 and/or third frame members 28 along the length of shipping container 20.

Next, as shown in FIGS. 4-6, two rows of photovoltaic modules 32 are attached onto first lateral rail 42 and second lateral rail 44 as follows. First, upper row 31 of photovoltaic modules 32 is pivot-connected to a connector on first lateral rail 42. Each photovoltaic module 32 of upper row 31 is then laid down to rest on second lateral rail 44. In some aspects, photovoltaic modules 32 of upper row 31 can couple to one or more connecting structures along the length of second lateral rail 44, further securing upper row 31 photovoltaic modules 32 when deployed. In further aspects, photovoltaic modules 32 of upper row 31 can couple to one or more connecting structures along the length of second frame member 26, also further securing upper row 31 photovoltaic modules 32 when deployed. In alternative embodiments, photovoltaic modules 32 of upper row 31 can also connect to coupling structures on inner rail 46.

Next, lower row 33 of photovoltaic modules 32 are pivot-connected to a connector on first lateral rail 42. Each photovoltaic module 32 of lower row 33 is then laid down to rest on outer rail 40. In some aspects, photovoltaic modules 32 of lower row 33 can couple to one or more connecting structures along the length of outer rail 40, further securing lower row 33 photovoltaic modules 32 when deployed. In further aspects, photovoltaic modules 32 of lower row 33 can couple to one or more connecting structures along the length of second frame member 26, also further securing lower row 33 photovoltaic modules 32 when deployed. In some aspects as shown, photovoltaic modules 32 of lower row 33 can extend laterally away from first lateral rail 42 past outer rail 40. Further, photovoltaic modules 32 of lower row 33 can extend laterally away from first lateral rail 42 past a free end of second frame member 26 distal from shipping container 20.

In further aspects, fastening hardware to secure photovoltaic modules 32 to any of outer rail 40, first lateral rail 42, second lateral rail 44, and inner rail 46 can include clamps, T-bolts, screws, nuts, keyed connectors configured to couple with grooves in photovoltaic module 32 frame, double-keyed connectors configured to couple with grooves in photovoltaic module 32 frame, and the like.

In various aspects, photovoltaic modules 32 used for photovoltaic array 30 can be a multi-cell solar panels, where each photovoltaic modules 32 can be, for example, a 32-cell panel, a 60-cell panel, a 72-cell panel, a 80-cell panel, a 96-cell panel or another multi-cell panel as known in the industry. For any given microgrid 10, photovoltaic modules 32 should be of equal size and/or power generation in order optimally use the power generated by all photovoltaic modules 32 of photovoltaic array 30. In various aspects, photovoltaic modules 32 can be from about forty pounds to fifty pounds (40 lbs.-50 lbs.) in weight. In various aspects, photovoltaic modules 32 can have a size that is about thirty-eight to forty-two inches in width (38″-42″) and about sixty to eighty inches (60″-80″) in length. Accordingly, for any given set of mounting rails on a pair of mounting structures 22 as shown, lower row 33 and upper row 31 can have three, four, five, six, or more than six photovoltaic modules 32, depending on the size of photovoltaic modules 32 used.

Depending on the size of photovoltaic modules 32 to be mounted, first frame member 24, second frame member 26, and third frame member 28 can be marked to be assembled in a manner to ensure sufficient support and distribution of the weight of photovoltaic modules 32. Accordingly, a triangular support structure formed by mounting structures 22 can have, in various embodiments, third frame member 28 connected to either of first frame member 24 and second frame member 26 at angles from thirty degrees (30°) to sixty degree (60°), or at angular increments within that range. Similarly, outer rail 40, first lateral rail 42, second lateral rail 44, and inner rail 46 can be connected to second frame member 26 at specific, identified locations in order to correctly mount and support the size of photovoltaic modules 32 used for the given installation. In other words, in some examples, a 60-cell panel can be relatively shorter than a 72-cell panel, which may require the mounting rails be positioned in relatively different locations. Thus, for an installation where photovoltaic modules 32 are 60-cell panels, outer rail 40, first lateral rail 42, and second lateral rail 44 can be spaced closer together along second frame members 26 to ensure that top and bottom sides of the 60-cell panels rest on mounting rails, as opposed to an installation where photovoltaic modules 32 are 72-cell panels, leading outer rail 40, first lateral rail 42, and second lateral rail 44 to be spaced relatively further apart.

FIGS. 4-6 show the assembly of a first portion of photovoltaic array 30 on one side of shipping container 20. It is understood that the construction of a second portion of photovoltaic array 30 on the opposite side of shipping container 20, mirroring the construction of the first portion of photovoltaic array 30, can follow the same steps as shown in FIGS. 4-6. Further, the assembly of the first portion of photovoltaic array 30 on one side of shipping container 20 is shown in FIGS. 4-6 along a part of the length of shipping container 20. It is understood that the construction of the portion of photovoltaic array 30 can extend along the entire length of either side of shipping container 20, provided that the number of mounting structures 22 and/or the distribution of mounting structures 22 along the entire length of shipping container 20 is sufficient to support the weight of the relevant portion of photovoltaic array 30.

In various aspects, photovoltaic modules 32 are pre-wired, such that photovoltaic modules 32 in any given row of photovoltaic modules 32 are easily electrically connected to each adjacent photovoltaic module 32. In other aspects, photovoltaic modules 32 in any given row can be manually wired to an adjacent photovoltaic module 32 within the same row or in an adjacent row. In such aspects, it remains advantageous to wire photovoltaic modules 32 together while mounting structures 22 are in a lowered position on the ground. As photovoltaic modules 32 are wired together, they form an electrical string, and each set of photovoltaic modules 32 that constitute an electrical string can have two electrical leads exposed that can further connect to electrical ports on shipping container 20.

In many aspects, when assembled, mounting structures 22 are secured in a rigid or static (nonadjustable) manner to ensure stability, orientation, and support of photovoltaic array 30. Indeed, mounting structures 22 can be triangular, where the use of first frame member 24, second frame member 26, and third frame member 28 assembled to generally form a triangle provides for a support structure for photovoltaic array 30 independent of the walls or columns of shipping container 20. In other words, once deployed and raised, any space frame used for mounting structures 22 can provide sufficient vertical structural support to photovoltaic array 30 above shipping container 20, although mounting structure 22 may be pivotally connected (directly or indirectly) to a bottom and/or external surface of shipping container 20. In some aspects, the support of photovoltaic array 30 with mounting structures 22 in the raised position does not require further adjustment of support members or struts. In other words, once microgrid 10 is assembled and deployed, components of mounting structure 22 should not be rotatable, telescoping, or otherwise adjustable for function as structural support of photovoltaic array 30. Further, in any embodiment of space frame used for mounting structures 22, mounting structures 22 are capable of supporting photovoltaic modules 32 and photovoltaic array 30 as a whole, independent of and without direct support from shipping container 20.

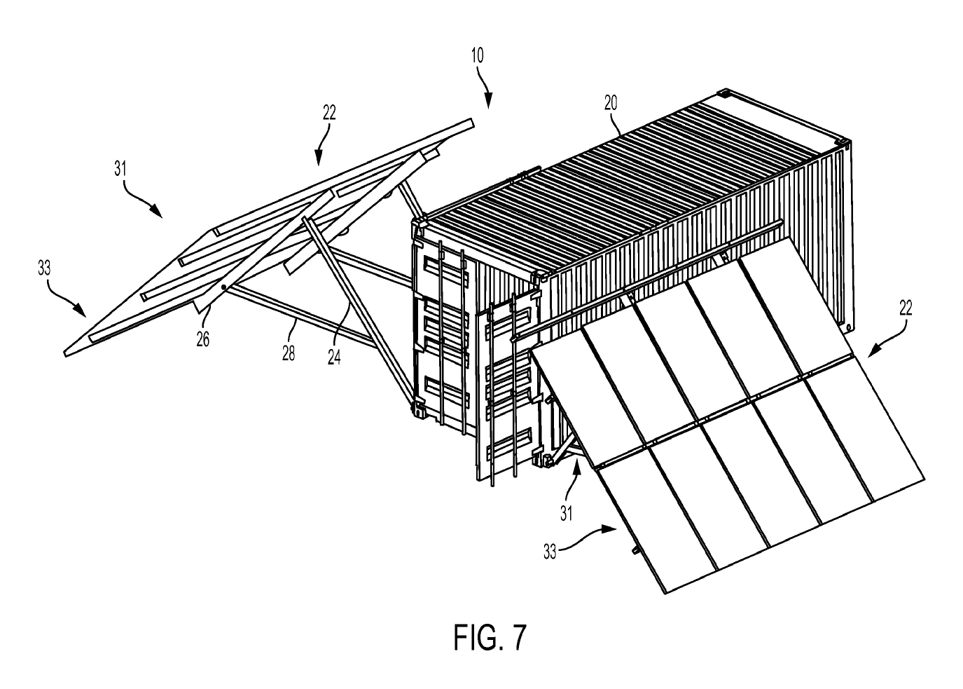

As shown in FIG. 7, pairs of mounting structures 22 with mounted photovoltaic modules 32 are shown assembled in lowered positions on either side of shipping container 20. As can be appreciated, an advantage of present microgrid 10 is that the assembly of individual photovoltaic modules 32 onto mounting structures 22 can be done on the ground. This allows for an assembly that is fast, easy, and typically will only require a pair of installers to perform the assembly. As noted above, each mounting structure 22 with mounted photovoltaic modules 32 on either side of shipping container 20 mirror each other. In some embodiments, mounting structures 22 on either side of shipping container 20 can directly mirror each other, being positioned at the same locations along the length of shipping container 20. In other embodiments, one or more of mounting structures 22 on either side of shipping container 20 can be positioned at different locations along the length of shipping container 20, such that mounting structures 22 on either side of shipping container 20 do not directly mirror each other, but the assembly of photovoltaic modules 32 do mirror each other.

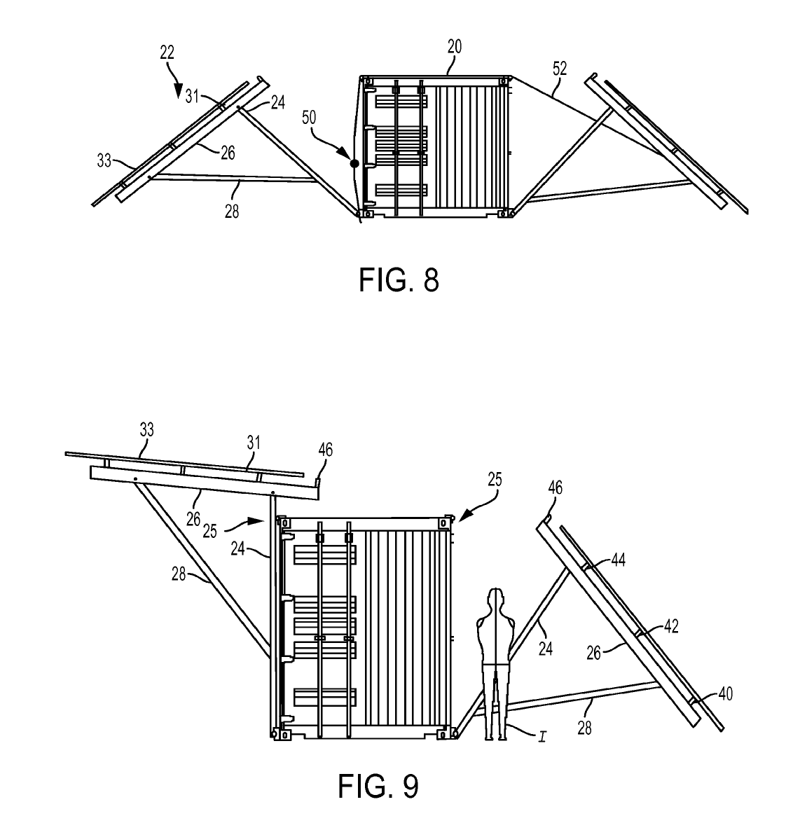

FIG. 8 is a side elevation view corresponding to FIG. 7, showing assembled mounting structures 22 with mounted photovoltaic modules 32 in lowered positions on either side of shipping container 20. Further shown are hoist 50 and cable 52, coupled to one of mounting structures 22 before raising mounting structure. In some aspects, hoist 50 and cable 52 can be arranged on the same side of shipping container 20 for raising one of mounting structures 22, and in other aspects (as shown), hoist 50 and cable 52 can be arranged on opposite sides of shipping container 20 for raising one of mounting structures 22.

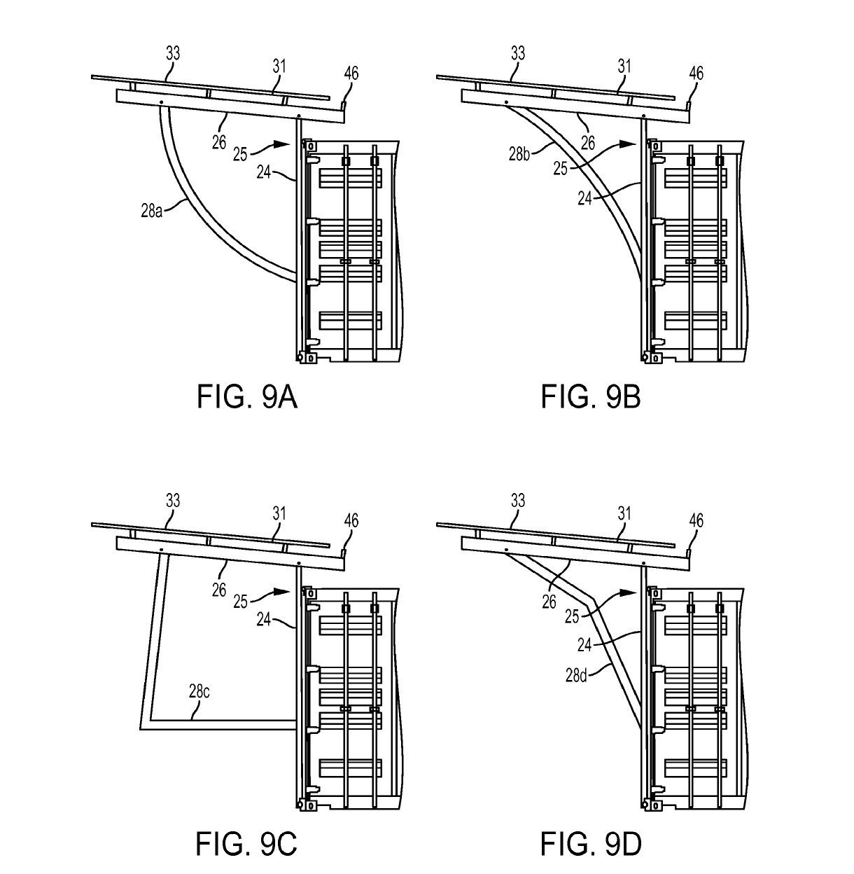

Next, as shown in FIGS. 8-10, mounting structures 22 are each rotated to their raised positions such that the final configuration of photovoltaic array 30 is positioned over the top of shipping container 20. Specifically, hoist 50 and cable 52 can be used to raise mounting structures 22. Preferably, hoist 50 can be hand-operated such that photovoltaic array 30 can be deployed to a raised or final position above shipping container 20 without requiring any motorized lifting mechanisms. Hoist 50 and cable 52 can be stored within shipping container 20 prior to use. In FIG. 9, an installer I is shown standing next to shipping container 20 for reference, and in an exemplary position to operate hoist 50. Depending on the position and arrangement of hoist 50 and cable 52, when an installer I operates hoist 50, cable 52 can be drawn so as to pull mounting structure 22, on either the same side of shipping container 20 or on the opposite side of shipping container 20, up from a lowered position to a raised position.

As shown in FIG. 9, mounting structure 22 with mounted photovoltaic modules 32 on the left-hand side of shipping container 20 is in a raised position. First frame member 24 is rotated (being pivotally connected to the bottom exterior side of shipping container 20) to a vertical position in the raised, final deployment. Preferably, first frame member 24 is attached to the upper side edge of shipping container 20 by latch 25. As can also be seen, second frame member 26 is rotated into a horizontal or near-horizontal position in the raised, final deployment. In some aspects, having second frame member 26 at a slightly non-horizontal angle (as shown) can be advantageous in that drainage of precipitation off of the upper row 31 and lower row 33 of photovoltaic modules 32 forming photovoltaic array 30 can be enhanced. In some embodiments, second frame member 26 and photovoltaic array 30 can be set at an angle of five degrees (5°) relative to the top of shipping container 20 to facilitate drainage. In other aspects, second frame member 26 and photovoltaic array 30 can be set at an angle of less than five degrees (<5°), ten degrees (10°), fifteen degrees (15°), greater than fifteen degrees (>15°), or at increments and gradients of angles thereof, relative to the top of shipping container 20 to facilitate drainage. Any such angle can also be selected to account for positioning photovoltaic array 30 to receive optimal incident solar radiation, while also accounting for potential risk due to wind that may affect the moment of photovoltaic array 30 in the raised operational position.

As can also be seen, the upper end of third frame member 28 can be used to provide support to the free end of second frame member 26 when the array is in its final raised position. Conversely, the free end of the second frame member 26 can be positioned sitting on the ground when the array is first being assembled (see FIGS. 2-6). In other aspects, second frame member 26 can be generally horizontal, while either side of photovoltaic array 30 can be mounted to have a degree of slope to facilitate drainage.

It can be understood that the space frame for mounting structure 22 can be different for various deployments of microgrid 10. FIG. 9A shows an alternative mounting structure 22 where third frame member 28a is an arched member oriented in a in a convex direction away from the walls of shipping container 20. FIG. 9B shows an alternative mounting structure 22 where third frame member 28b is an arched member oriented in a concave direction toward the walls of shipping container 20. FIG. 9C shows an alternative mounting structure 22 where third frame member 28c is an angled and/or two-piece member forming a generally boxed space frame. FIG. 9D shows an alternative mounting structure 22 where third frame member 28d is an angled, two-piece, and/or three-piece member forming a chevron space frame. In various embodiments, one or more variations of space frames described herein can be used for mounting structures 22 on any given shipping container 20.

Lifting an assembled side of mounting structure 22 and mounted photovoltaic modules 32 with hoist 50 and cable 52 can be accomplished by a single installer, having correctly tied cable to appropriate parts of mounting structure 22. As each photovoltaic module 32 can weigh about fifty pounds, the mounted upper row 31 and lower row 33 of photovoltaic modules 32 can in aggregate weigh about five hundred pounds, with mounting structure 22 on which upper row 31 and lower row 33 are mounted itself weighing about one hundred pounds. Hoist 50 and cable 52 allow for a single installer to raise up an assembled side of mounting structure 22 and mounted photovoltaic modules 32 without the need for engine-driven machinery or a crane, or even scaffolding.

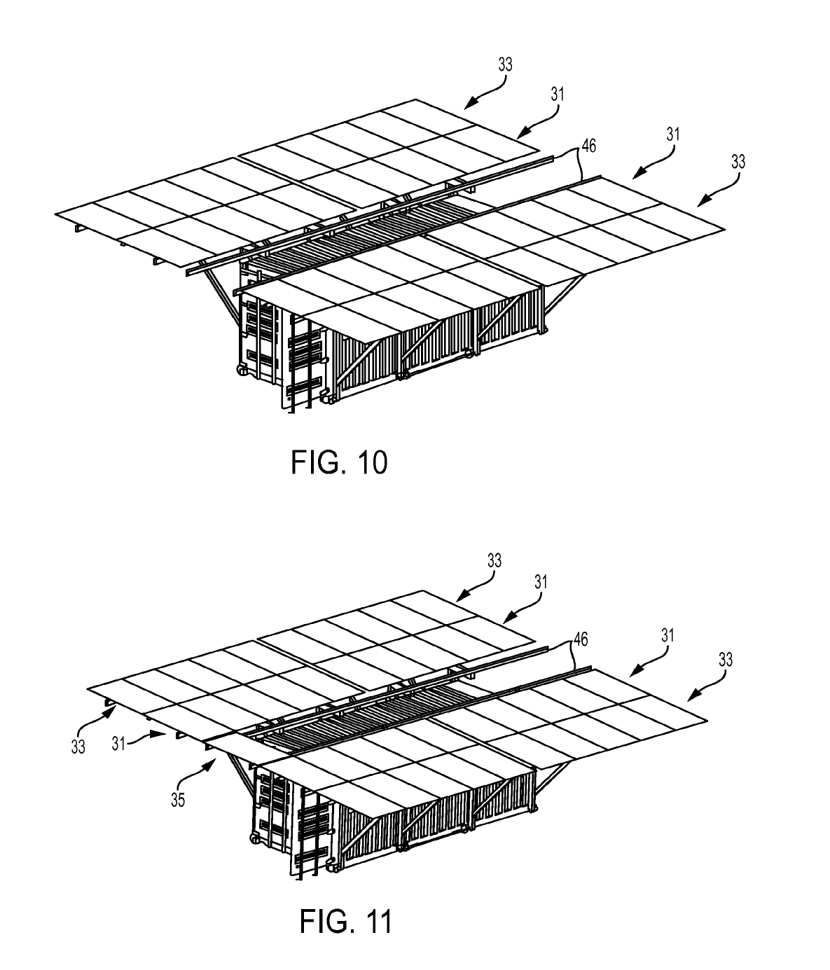

FIG. 10 shows photovoltaic array 30 near completion, with mounting structures 22 on both sides of shipping container 20 both rotated to raised positions. Inner rails 46 from both mounting structures 22 are located above the top of shipping container 20. Further, for both portions of photovoltaic array 30, lower row 33 is positioned more distally from shipping container 20 than respective upper rows 31. FIG. 10 further shows additional mounting structures 22 located along the length of shipping container 20, Specifically, four mounting structures 22 are positioned along the length of each side of shipping container 20, providing for support of upper rows 31 and lower rows 33 on either side of shipping container 20. On both sides of shipping container 20, lower rows 33 extend past free ends of second frame members 26, forming lateral edges of photovoltaic array 30. In some embodiments, also shown in FIG. 10, the mounting rails and photovoltaic modules 32 can extend past the ends of shipping container 20, forming end edges of photovoltaic array 30. Hoist 50 and cable 52 can be disconnected from the exterior of shipping container 20 once mounting structures 22 are in the raised position.

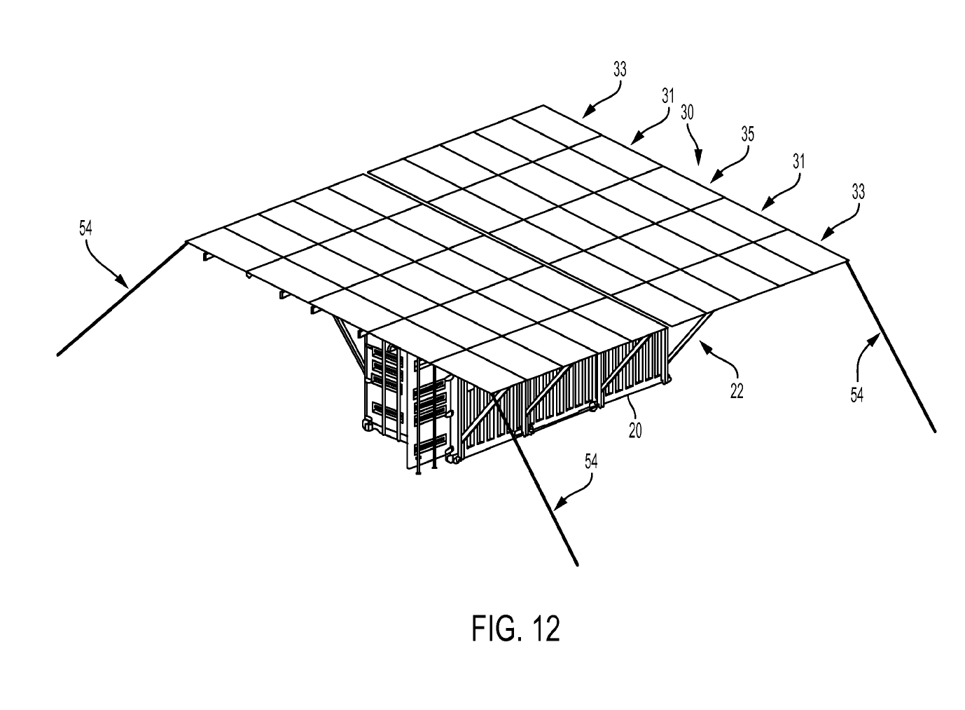

FIGS. 11-12 show the installation of a center row 35 of photovoltaic modules 32 joining the two sides of photovoltaic array 30. Specifically, installer I simply climbs on top of shipping container 20 and proceeds to install the final center row 35 of photovoltaic modules 32 along the top of the shipping container. Center row 35 of photovoltaic modules 32 is installed by connecting them to inner rails 46 from mounting structures 22 on either sides thereof. Once installed, center row 35, both upper rows 31, and both lower rows 33 of photovoltaic modules form a completed photovoltaic array 30 in a deployed configuration.

In various embodiments, the position along second frame members 26 where inner rail 46 is mounted, on both sides of shipping container 20, can be set to account for the size of photovoltaic modules 32 used for the installation. In other words, where microgrid 10 uses 60-cell photovoltaic modules 32, inner rails 46 on either side of shipping container 20 may be mounted along their respective second frame members 26 such that, when in the raised position, both inner rails 46 are sufficiently close together to support photovoltaic modules 32 of center row 35. Conversely, where microgrid 10 uses 72-cell photovoltaic modules 32, inner rails 46 on either side of shipping container 20 may be mounted along their respective second frame members 26 further apart from each other as compared to the mounting configuration for 60-cell photovoltaic modules 32, while still at a distance sufficiently close together to support photovoltaic modules 32 of center row 35. Accordingly, second frame members 26 can have markings to indicate correct positioning of outer rail 40, first lateral rail 42, second lateral rail 44, and inner rail 46 along the length of second frame members 26 for installations using 60-cell photovoltaic modules 32, 72-cell photovoltaic modules 32, or other sized photovoltaic modules 32.

Furthermore, in various embodiments, any or all of first frame member 24, second frame member 26, third frame member 28, outer rail 40, first lateral rail 42, second lateral rail 44, and inner rail 46 can include instructive markings, indicating to an installer I how to connect the components to each other. For example, instructive markings an include a number of indentations or ridges in a steel component that reflect the number of rotations, or fraction of rotations, needed to apply to a rotating connector that can couple any of photovoltaic module 32, first frame member 24, second frame member 26, third frame member 28, outer rail 40, first lateral rail 42, second lateral rail 44, or inner rail 46 to another component of the structure.

In some exemplary embodiments as shown, fifty photovoltaic modules 32 are used. In such embodiments, each photovoltaic module 32 is a 350 kW module. As a result, 17.5 kW of power can be provided in an exemplary microgrid 10 installation. It is to be understood, however, that other numbers of modules (and modules of other power ratings) can be used, all keeping within the scope of the presently claimed system. Accordingly, in further embodiments, microgrid 10 can be expected to generate from about 20 kW to about 40 kW of power. In further embodiments, by use of various photovoltaic modules and/or power control systems, microgrid 10 can be configured to provide less than 17.5 kW of power, or alternatively, greater than 40 kW of power.

In optional embodiments, as seen in FIG. 12, external guide wires 54 can be secured from each of the four corners of photovoltaic array 30, extending downwardly and/or outwardly to locations on the ground to give the overall system of microgrid 10 greater stability in high winds. In various embodiments, one, two, or three external guide wires 54 can be secured from any one or all of the four corners of photovoltaic array 30. External guide wires 54 can be steel cables, textile-based cables, or the like, and can be secured into the ground with anchors as known in the field.

Advantages of the present system include the fact that the mounting structures 22 (including, but not limited to, first frame member 24, second frame member 26, and third frame member 28) and all of photovoltaic modules 32 can be stored within shipping container 20 during transport to the jobsite. During assembly, shipping container 20 acts as a counter-balance to mounting structures 22 and remains in position as the mounting structures 22 are raised on opposite sides thereof. Also advantageously, an installer standing on the ground can comfortably reach each of the three mounting rails, outer rail 40, first lateral rail 42, and second lateral rail 44, allowing for installation of upper row 31 and lower row 33 of photovoltaic modules 32 from the ground when mounting structures 22 are in their initial, lowered positions. Further, is can be understood that the present system allows for construction of microgrid 10 without the need for scaffolding to support photovoltaic modules during assembly. Indeed, in some aspects, aside from hoist 50 and cable 52 for moving photovoltaic modules into an operations position, only a ladder to get on top of shipping container 20 or to access inner rails 46 when in a raiser position will be needed in order to finish installing center row 35 of photovoltaic array 30.

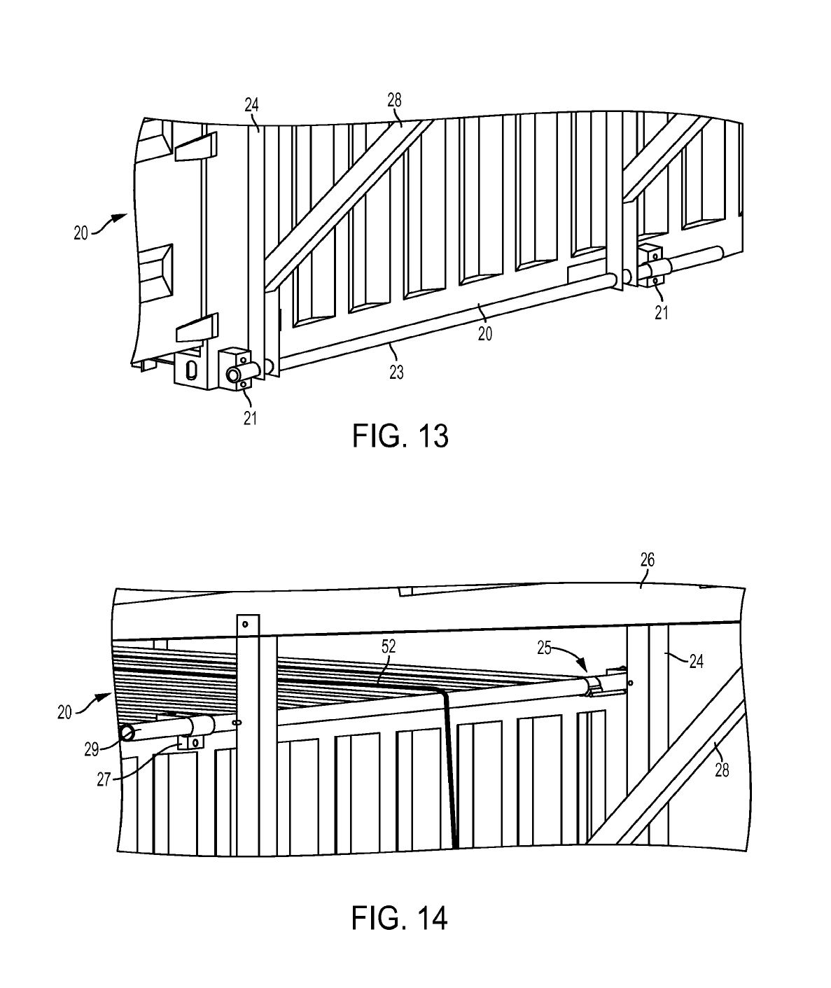

FIG. 13 is a detail view of a bottom side of shipping container 20 showing further details of the pivot connection between first frame members 24 and shipping container 20. Specifically, first frame members 24 can be configured to couple with and rotate around lower bar 23. The axis of rotation defined by lower bar 23 is parallel to the length of shipping container 20, and allows for motion of a mounting structure 22 (or mounting structures 22 connected by at least one mounting rail) from the lowered position to the raised position, as described above. Lower bar 23 can be attached and secured to shipping container by lower joints 21. In some embodiments as shown, lower joints 21 can be positioned proximate or adjacent to where first frame members 24 connect with lower bar 23. In other embodiments, one or more of lower joints 21 can be positioned at a location along lower bar 23 that is not adjacent to where first frame members 24 connect with lower bar 23.

FIG. 14 is a detail view of a top perspective view of shipping container 20 showing further details of cable 52 and components for attaching the top ends of the first frame members 24 to the top side edges of shipping container 20 by way of latches 25. Latches 25 can couple with matching receiving structures (e.g. holes) in first frame members 24, with a projection of latch 25 fitting into the receiving structure of first frame member 24. As shown, latch 25 can move along upper bar 29 such that a projection of latch 25 can slide into a hole in first frame member 24. In various aspects, the engagement structure of latches 25 with first frame member 24 can be a bolting, clamping, hooking, or such fastening structure. Latches 25 can be attached and secured to shipping container 20 via upper bar 29 and upper joints 27. In some embodiments as shown, upper joints 27 can be positioned proximate or adjacent to where first frame members 24 connect with upper bar 29. In other embodiments, one or more of upper joints 27 can be positioned at a location along upper bar 29 that is not adjacent to where first frame members 24 connect with upper bar 29.

Advantages of lower joints 21 and upper joints 27 include the ability for lower joints 21 and upper joints 27 to directly couple with and secure to corner casings, corner fittings, top side rails, bottom side rails, forklift pockets, hubs, and other standard external structures of ISO shipping containers 20. Thus, in many embodiments, no additional modification is necessary to use any given shipping container 20 for a microgrid 10.

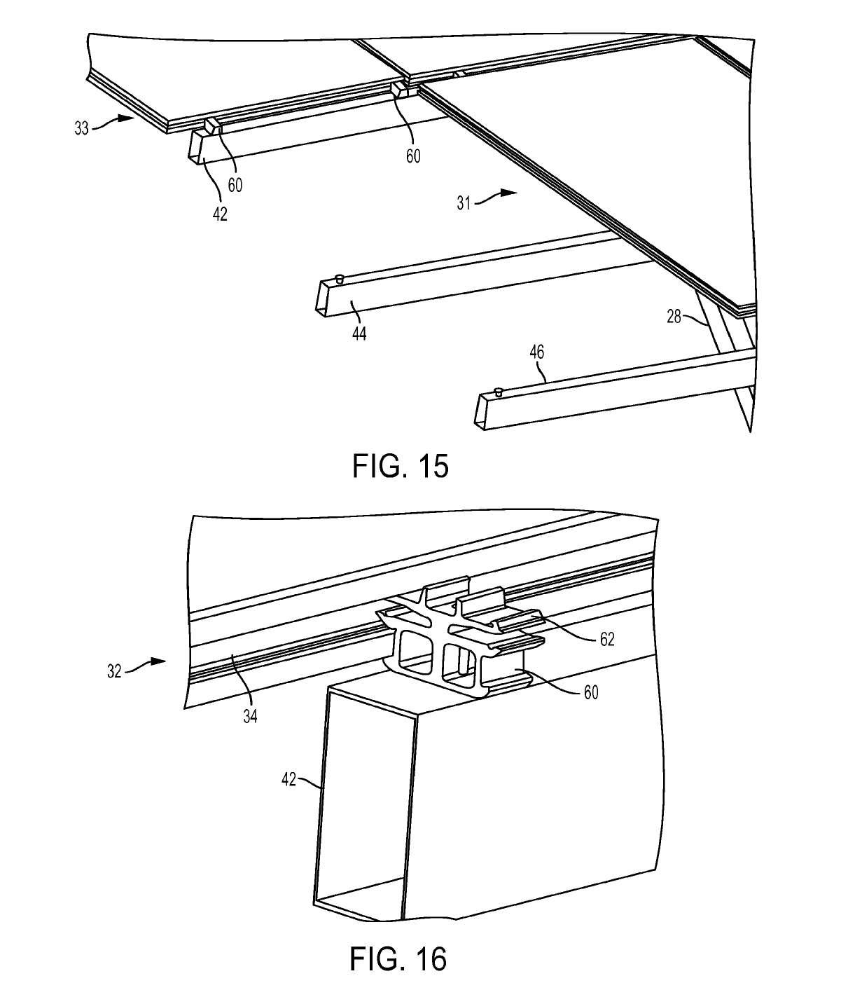

FIG. 15 shows further details of the three mounting rails, first lateral rail 42, second lateral rail 44, and inner rail 46, and photovoltaic modules 32 of upper row 31 and lower row 33 mounted thereon. Further, FIG. 16 shows details of connector 60 on second lateral rail 44 as seen in FIG. 15. Connector 60 is optionally a two-headed male connector that has tongues 62 which are received into (and lock into) side grooves 34 in photovoltaic modules 32. As such, during installation of photovoltaic modules 32 when mounting structures 22 are in their lowered positions, connector 60 holds onto the bottom edges of photovoltaic modules 32 in upper row 31 and the top edges of photovoltaic modules 32 in bottom row 33. It is to be understood, however, that the present invention is not limited to only connector 60 as shown. Rather, other module-to-rail connectors can be used while still being within the scope of the present disclosure. For example, wraparound connectors that grab onto the top and bottoms of the photovoltaic modules 30 can be used instead of, or in combination with connector 60 of the present disclosure.

In further aspects, the use of outer rail 40, first lateral rail 42, second lateral rail 44, and inner rail 46 in combination with connectors 60 as described herein obviates any need for additional mounting frames surrounding or connected to photovoltaic modules 32. The assembly and configuration of the present system thereby provides of a more efficient use of photovoltaic array 30 surface area for collecting solar energy, in comparison with photovoltaic modules 32 further framed individually or in groups.

FIG. 15 and FIG. 16 show that mounting rails such as outer rail 40, first lateral rail 42, second lateral rail 44, and inner rail 46, can be constructed to be hollow, minimizing the weight of the mounting rails. The mounting rails can be constructed of materials such as steel, aluminum, titanium, or alloys or composites thereof, such that the overall weight of microgrid 10 is minimized for both transport, while retaining sufficient structural strength to support photovoltaic array 30. In such aspects, any or all of first frame member 24, second frame member 26, third frame member 28, outer rail 40, first lateral rail 42, second lateral rail 44, and inner rail 46 can all be constructed of tubular steel. In other aspects, any or all of first frame member 24, second frame member 26, third frame member 28, outer rail 40, first lateral rail 42, second lateral rail 44, and inner rail 46 can all be constructed of U-shaped, L-shaped, or J-shaped steel, to allow for flat packing and greater shipping density, while also minimizing weight, for ease of transport.

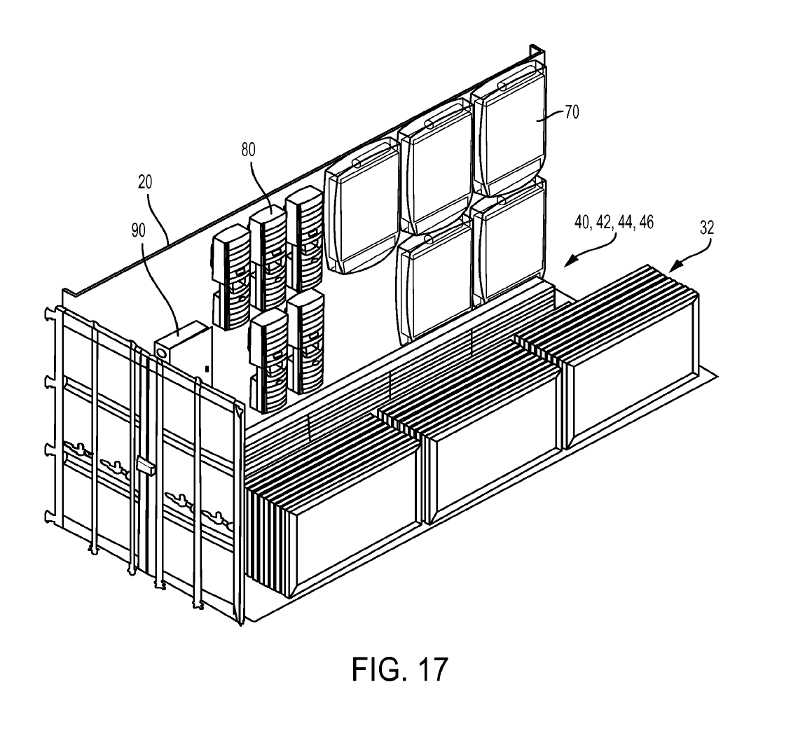

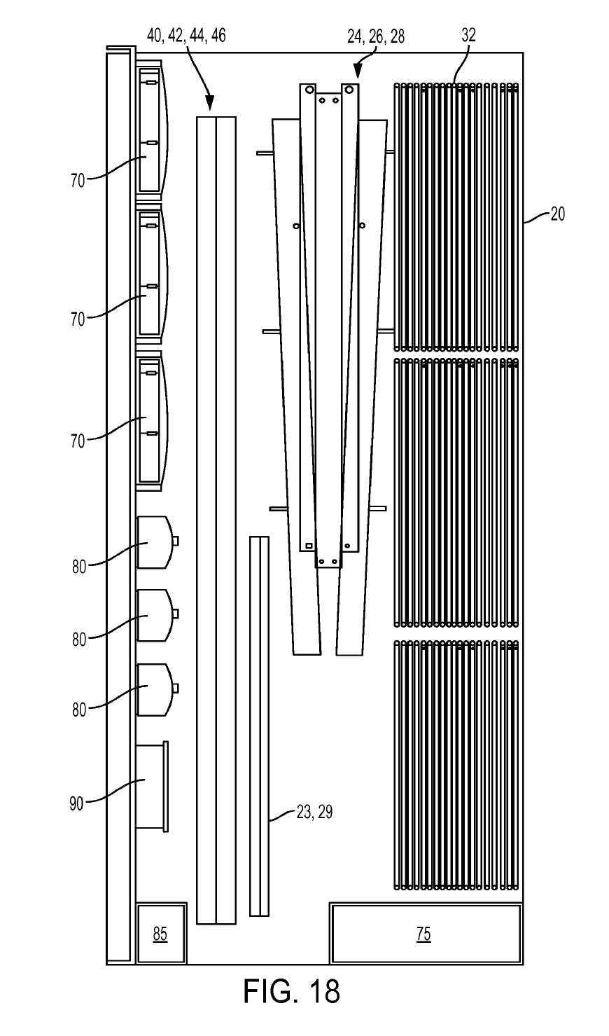

FIG. 17 and FIG. 18 show storage of the components of the present system within shipping contain 20 prior to field deployment, and arranged for transport. FIG. 17 is a perspective cut-away view of shipping container 20 and FIG. 18 is a top plan view of shipping container 20 with components of the present system disposed therein. Specifically, components of the mounting system including first frame member 24, second frame member 26, third frame member 28, outer rail 40, first lateral rail 42, second lateral rail 44, and inner rail 46 can be stored in the center of shipping container 20. Photovoltaic modules 32 can be stored next to the mounting rails and mounting structure 22 components. Optionally, one or more batteries 70, inverters 80, and associated electronics and control systems 90 can all be located within shipping container 20. Similarly, assembly or stability components including, but not limited to, hoist 50, cable 52, and external guide wires 54 can be transported and stored within shipping container 20. Particularly, assembly or stability components for the assembled system can be stored within storage box 75 within shipping container 20. Optionally, a separate generator, such as a diesel generator can be stored within shipping container 20, that can be connected to microgrid 10 and provide electrical power at times when solar power is not generated from photovoltaic array 30 (e.g. at night, under cloud cover, etc.) to ensure that microgrid 10 can function as a power supply as needed.

After field deployment, the components of one or more batteries 70, inverters 80, and control systems 90 can remain securely locked within shipping container 20. Batteries 70, inverters 80, and control systems 90 can modularly connect to mounting structures and electrical ports within shipping container 20, such that batteries 70, inverters 80, and control systems 90 can be “plug-and-play” components, straightforward to configure and able to quickly bring to a functional, operating state. Additionally, within shipping container 200, components of one or more batteries 70, inverters 80, and control systems 90 can be kept shaded and cool (both by being within dark shipping container 20, and by virtue of the fact that shipping container 20 is itself shaded by array 30 thereabove). In various aspects, batteries 70 can be mounted to the interior sides of shipping container 20 (e.g. as “power walls”), or located on the floor of shipping container 20. In such aspects, batteries 70 can be lithium-ion batteries, lead-acid batteries, flow batteries, or other such battery types that can store energy as needed, proportional to the electrical power generated by microgrid 10.

FIG. 18 further shows electrical connection box 85, which can be located within shipping container 20 along any available surface of shipping container 20. Electrical connection box 85 provides for connection from microgrid 10 to external power loads (i.e. the devices or local grid to which microgrid 10 is connected). Electrical connection box 85 can have an electrical connection port accessible from the exterior of shipping container 20, to which external power loads can be connected. Electrical connection box 85 can be located proximate to, or have ports in, the ceiling, side walls, and/or floor of shipping container 20, such that electrical connections to microgrid 10 can easily couple to microgrid 10 regardless of location (e.g. a trenched electrical connection can couple to electrical connection box 85 via a port in the bottom of a side wall, a tower or electrical pole can couple to electrical connection box 85 via a port in the ceiling, etc.).

Photovoltaic modules 32 are connected together in electrical strings. In some aspects, each upper row 31, lower row 33, and center row 35 of photovoltaic modules 32 are electrically coupled to form an electrical string. In some aspects, each pair of upper row 31 and lower row 33 of photovoltaic modules 32 on either side of shipping container 20 are electrically coupled to form an electrical string. Such electrical strings can include five, ten, fifteen, twenty, or more than twenty photovoltaic modules 32 depending on the configuration of the overall system. Each of these strings from are coupled to batteries 70, inverters 80, and/or control systems 90 within shipping container 20 through one or more ports in the ceiling or upper side walls of shipping container 20. Depending on the type and number of photovoltaic modules 32 for upper row 31, lower row 33, and center row 35 of a given photovoltaic array 30, photovoltaic array 30 can have one, two, three, four, or five electrical strings for the electrical output from photovoltaic array 30 leading back into a combiner box and/or electrical connection box 85 of shipping container 20.

In various embodiments, inverters 80 are centrally located within shipping container 20 as shown in FIG. 17 and FIG. 18, connected to electrical strings from photovoltaic array 30, and converting the aggregate DC power generated from photovoltaic array 30 to AC power. In other embodiments, micro-inverters (not shown) can be located on the back side of each photovoltaic modules 32 (i.e. on the non-silicon panel side), converting the aggregate DC power generated from each photovoltaic module 32 to AC power, and thereby providing AC power to the centralized control systems 90 and electronics within shipping container 20. In either embodiment, microgrid 10 can provide AC power to external power loads. In various aspects, control systems 90 can be manually controlled circuits or circuits controlled via microprocessor//computer system. As needed, further electrical converters can be provided within shipping container 20 to rectify, amplify, regulate or otherwise modify the electrical power provided by microgrid 10 to an external power load.

In various embodiments, shipping container 20 can be further configured to accommodate cooling apparatus. Batteries 70, inverters 80, and control systems 90 within shipping container 20 can generate heat during operation. To avoid excessive heat within shipping container 20, shipping container 20 can have vents, a local air-conditioning system to regulate temperature and/or humidity, or one or more fans built into or mounted within shipping container 20 that can cool the components inside shipping container 20.

In alternative embodiments, as noted above, shipping container 20 can be a thirty foot (30′) or a forty foot (40′) freight container, with sufficient components to assemble mounting structures 22 and photovoltaic array 30 to mount along a portion of or the entirety of the length of shipping container 20.

Disassembly of microgrid 10 installation can proceed in the opposite order of the assembly steps described above. Hoist 50 and cable 52 can be used to lower mounting structures 22 from the raised position to the lowered position in a controlled manner. Disassembly of mounting structures 22 carries the same advantage as assembly, in that mounting structures 22 are easily accessible by one or more installers I when in a lowered position on the ground. Once disassembled, components of microgrid 10 can be packed within shipping container 20 for further transport and/or use at another site. Again, as with assembly, disassembly of microgrid 10 can be accomplished with a minimal number of installers I, and without the need for scaffolding, a crane, or engine-driven machinery.

It is further understood that a microgrid network can be formed by one or more of the microgrids 10 described herein. In some embodiments, a microgrid network can include one or more field-deployable self-contained photovoltaic power systems, where each such power system includes shipping container 20, two or more sets of mounting structures 22, each mounting structure 22 being pivotally connected to a lower exterior edge or surface of shipping container 20, each mounting structure 22 configured to rotate between a lowered position and a raised position, with at least one set of mounting structures 22 on either longitudinal side of shipping container 20, and a set of photovoltaic modules 32, where each photovoltaic module 32 is configured to couple onto one set of mounting structures 22 when mounting structures 22 are in the lowered position, and where each photovoltaic module 32 is configured to couple with one set of mounting structures 22 on either side of the photovoltaic module 32 when mounting structures 22 are in the raised position; and where each of the self-contained photovoltaic power systems is electrically connected to a local, off-grid power load. In such embodiments, the microgrid network can have one or more inverters 80 electrically connected to the set of photovoltaic modules 32, where one or more inverters 80 can be located within shipping container 20 (for each microgrid 10), on each photovoltaic module 32 (on the non-silicon panel side), or a combination thereof. Further, the microgrid network can be arranged and configured such that the collection of microgrids 10 are electrically connected to each other, and are electrically connected to the local, off-grid power load as a single power source.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A field-deployable self-contained photovoltaic power system, comprising:
a shipping container having a bottom portion, a roof portion, and wall portions separating the bottom portion and the roof portion;
a plurality of mounting structures, each mounting structure comprising at least one space frame, configured to support at least one photovoltaic module independent of the shipping container, and pivotally connected to a bottom exterior surface of the shipping container, and movable between a lowered position and a raised position; and
a plurality of photovoltaic modules, each photovoltaic module being attachable onto one of the mounting structures,
wherein the plurality of mounting structures in the lowered position are configured to receive and attach to the plurality of photovoltaic modules, and wherein the plurality of mounting structures in the raised position, with the plurality of photovoltaic modules attached thereto, are disposed to form a photovoltaic array.

2. The system of claim 1, wherein the plurality of mounting structures comprises mounting structures on opposite sides of the shipping container, such that the plurality of mounting structures in the raised position, with the plurality of photovoltaic modules attached thereto, supports the photovoltaic array which extends over the top of the shipping container.

3. The system of claim 2, wherein the photovoltaic module array includes a center row of photovoltaic modules suspended by both of the mounting structures on opposites sides thereof.

4. The system of claim 1, wherein each mounting structure comprises:
a first frame member having a bottom end rotatably connected to a bottom edge of the shipping container;
a second frame member connected to a top end of the first member; and
a third frame member connected at opposite ends to each of the first and second frame members, wherein, with the mounting structure in the raised position, the third frame member supports a free end of the second frame member.

5. The system of claim 4, wherein, with the mounting structure in the raised position, the first frame member is rotated to a vertical position, is attached onto a top edge of the shipping container, and is in the raised position above the shipping container.

6. The system of claim 4, wherein, with the mounting structure in the raised position, the second frame member is rotated to a generally horizontal position above the shipping container.

7. The system of claim 4, wherein the third frame member is connected at 45 degree angles to each of the first and second frame members.

8. The system of claim 1, further comprising guide wires extending outwardly away from at least one of the four corners of the photovoltaic array.

9. The system of claim 4, further comprising mounting rails spanning across each of the second frame members in the plurality of mounting structures disposed parallel to one another.

10. The system of claim 9, wherein the mounting rails comprise an outer mounting rail, a first lateral mounting rail, a second lateral mounting rail, and an inner mounting rail.

11. The system of claim 10, wherein an upper row and a lower row of photovoltaic modules are pivot connected onto the first lateral mounting rail with bottom edges of the upper row of photovoltaic modules being connected to the first lateral mounting rail and top edges of the lower photovoltaic modules being connected to the first lateral mounting rail.

12. The system of claim 1, further comprising:
at least one inverter configured to convert energy generated by the photovoltaic array from direct current to alternating current; and
at least one battery in the shipping container, the battery being electrically connected to store energy generated by the photovoltaic array.

13. A method of deploying a self-contained photovoltaic power system, comprising:
withdrawing components for a plurality of mounting structures and a plurality photovoltaic modules from within a shipping container;
assembling the plurality of mounting structures on opposite sides of the shipping container, each mounting structures pivotally connected to a bottom exterior surface of the shipping container, and movable between a lowered position and a raised position;
on the opposite sides of the shipping container, connecting the plurality of mounting structures to each other with a plurality of mounting rails;
with the plurality of mounting structures in a lowered position on the ground, attaching a portion of the plurality of photovoltaic modules to the mounting rails;
manually raising each plurality of mounting structures on opposite sides of the shipping container to the raised position, disposing the attached portion of the plurality of photovoltaic modules above the shipping container; and
mounting a further portion of the plurality of photovoltaic modules between the mounting structures in the raised position, thereby forming a photovoltaic array.

14. The system of claim 13, wherein manually raising each plurality of mounting structures is performed with a hoist and cable manually operable by an installer.

15. The system of claim 13, wherein the shipping container acts as a counter-balance and remains in position as the mounting structures are raised on opposite sides thereof.

16. The system of claim 13, wherein mounting a further portion of the plurality of photovoltaic modules between the mounting structures in the raised position is performed by an installer positioned on top of the shipping container.

17. The system of claim 1, wherein a portion of the plurality of photovoltaic modules are attached to the mounting rails on a side of the shipping container in two rows by an installer on the ground.

18. A microgrid network, comprising:
one or more field-deployable self-contained photovoltaic power systems, each comprising:
a shipping container;
two or more sets of mounting structures, each mounting structure being pivotally connected to a lower exterior edge of the shipping container, each mounting structure configured to rotate between a lowered position and a raised position, with at least one set of mounting structures on either longitudinal side of the shipping container; and
a set of photovoltaic modules, where each photovoltaic module is configured to couple onto one set of the mounting structures when the mounting structures are in the lowered position, and where each photovoltaic module is configured to couple with one set of mounting structures on either side of the photovoltaic module when the mounting structures are in the raised position; and
wherein each of the one or more of field-deployable self-contained photovoltaic power systems is electrically connected to a local off-grid power load.

19. The microgrid network of claim 18, wherein one or more inverters are electrically connected to the set of photovoltaic modules with the one or more inverters located within the shipping container for each photovoltaic power system, on each photovoltaic module of the set photovoltaic modules, or a combination thereof.

20. The microgrid network of claim 18, wherein the one or more field-deployable self-contained photovoltaic power systems are electrically connected to each other and are electrically connected to the local off-grid power load as a single power source.
